(19) United States
(12) Patent Application Publication
(10) Pub. No.: US 2019/0031926 A1
(43) Pub. Date: Jan. 31, 2019

(54) PRESSURE-SENSITIVE ADHESIVE COMPOSITION

(71) Applicant: 3M INNOVATIVE PROPERTIES COMPANY, St. Paul, MN (US)

(72) Inventor: Wanshik Yoon, Seoul (KR)

(73) Assignee: 3M INNOVATIVE PROPERTIES COMPANY, St. Paul, MN (US)

(21) Appl. No.: 16/072,294

(22) PCT Filed: Jan. 20, 2017
(86) PCT No.: PCT/US17/14266

§ 371 Date: Jul. 24, 2018

(30) Foreign Application Priority Data
Jan. 27, 2016 (KR) 10-2016-0010174

(51) Int. Cl. C09J 7/38; C08F 220/46; C09J 133/20

(52) U.S. Cl. CPC C09J 7/385; C09J 2467/006; C09J 133/20; C08F 220/46

(57) ABSTRACT

There is provided a pressure-sensitive adhesive composition comprising a polymer formed by polymerizing a plurality of monomers. Here, the monomers include i) one or more selected from the group consisting of 2-ethylhexyl acrylate, butyl acrylate, isooctyl acrylate, 2-propylheptyl acrylate, n-octyl acrylate, 2-ethylhexyl methacrylate, butyl methacrylate, isooctyl methacrylate, 2-propylheptyl methacrylate, and n-octyl methacrylate, ii) one or more selected from the group consisting of acrylonitrile and methacrylonitrile, and iii) one or more selected from the group consisting of acrylic acid and methacrylic acid. The pressure-sensitive adhesive composition has high adhesive strength and water repellency, and particularly exhibits excellent chemical resistance and maintains an adhesive strength even when coming in contact with chemicals.

### FIELD OF THE INVENTION

The present invention relates to a pressure-sensitive adhesive composition, and more particularly, to a pressure-sensitive adhesive composition having chemical resistance.

### BACKGROUND ART OF THE INVENTION

Pressure-sensitive adhesive (PSA) tapes are virtually present everywhere for household and industrial purposes. A pressure-sensitive adhesive tape generally includes a pressure-sensitive adhesive layer disposed on a substrate. Pressure-sensitive adhesives exhibit a pressure-sensitive adhesive property at a temperature at which the pressure-sensitive adhesive tape is used, and is attached to various articles under only a proper pressure to form adhesive bonds.

According to the Pressure-Sensitive Tape Council, pressure-sensitive adhesives (PSAs) are known to have characteristics as follows: (1) a strong and permanent pressure-sensitive adhesive property, (2) adhesion using a pressure less than or equal to finger pressure, (3) a sufficient ability to remain on a target object, and (4) a sufficient cohesive strength to be cleanly removed from the target object. Materials known to have an excellent function as the pressure-sensitive adhesives (PSAs) include a polymer designed and formulated to exhibit desired viscoelastic characteristics, resulting in a desired balance of a pressure-sensitive adhesive property, a peel adhesive property and a shear retention force. In general, the pressure-sensitive adhesives have a characteristic of showing a pressure-sensitive adhesive property at room temperature (for example, 20° C.). It should be noted that the pressure-sensitive adhesives do not include a composition even when the composition is simply adhered or attached to a surface.

This requirement is generally evaluated using a test designed to separately measure a pressure-sensitive adhesive property, an adhesive property (a peel strength), and a cohesive property (a shear retention force), as disclosed by A. V. Pocius in Adhesion and Adhesives Technology: An Introduction, 2^{nd} Ed., Hanser Gardner Publication, Cincinnati, Ohio, 2002. These measurements are put together to balance the characteristics widely used to characterize PSA.

There has been an increasing demand for performance requirements due to the extensive use of the pressure-sensitive adhesive tapes for years. For example, pressure-sensitive adhesives having high adhesive strength, water repellency and chemical resistance need to be provided.

Conventional pressure-sensitive adhesives have a problem in that they have a reduced adhesive strength when they come in contact with chemicals. In particular, pressure-sensitive adhesives used in wearable devices and the like are easily exposed to household chemicals such as oleic acid during their lifetimes, and thus require chemical resistance.

### DETAILED DESCRIPTION OF THE INVENTION

The present invention is directed to a pressure-sensitive adhesive composition having excellent adhesive strength, exhibiting water repellency and chemical resistance, and maintaining a constant adhesive strength even when coming in contact with chemicals.

### Means for Solving the Invention

To solve the prior-art problems as described above, according to an aspect of the present invention, there is provided a pressure-sensitive adhesive composition including a polymer formed by polymerizing a plurality of monomers. Here, the monomers include i) one or more selected from the group consisting of 2-ethylhexyl acrylate, butyl acrylate, isooctyl acrylate, 2-propylheptyl acrylate, and n-octyl acrylate, 2-ethylhexyl methacrylate, butyl methacrylate, isooctyl methacrylate, 2-propylheptyl methacrylate, and n-octyl methacrylate, ii) one or more selected from the group consisting of acrylonitrile and methacrylonitrile, and iii) one or more selected from the group consisting of acrylic acid and methacrylic acid.

The monomers may be polymerized in a solvent using an initiator.

The content of i) one or more selected from the group consisting of 2-ethylhexyl acrylate, butyl acrylate, isooctyl acrylate, 2-propylheptyl acrylate, n-octyl acrylate, 2-ethylhexyl methacrylate, butyl methacrylate, isooctyl methacrylate, 2-propylheptyl methacrylate, and n-octyl methacrylate may be in a range of 63 to 84% by weight, the content of ii) one or more selected from the group consisting of acrylonitrile and methacrylonitrile may be in a range of 10 to 30% by weight, and the content of iii) one or more selected from the group consisting of acrylic acid and methacrylic acid may be in a range of 3 to 15% by weight, based on the total weight of the polymer.

The pressure-sensitive adhesive composition may further include a crosslinking agent, and the crosslinking agent may include one or more selected from the group consisting of an isocyanate-based crosslinking agent, a bisamide-based crosslinking agent, a chelate-based crosslinking agent, a melamine-based crosslinking agent, an epoxy-based crosslinking agent, an amine-based crosslinking agent, and a urea-based crosslinking agent.

According to another aspect of the present invention, there is provided a pressure-sensitive adhesive article including a substrate, and a pressure-sensitive adhesive layer disposed on the substrate. Here, the pressure-sensitive adhesive layer includes the pressure-sensitive adhesive composition according to the present invention.

### Advantageous Effects

The pressure-sensitive adhesive composition according to the present invention has excellent adhesive strength, and exhibits water repellency and chemical resistance. That is, the pressure-sensitive adhesive composition according to the present invention can maintain an adhesive strength even when coming in contact with chemicals.

### DETAILED DESCRIPTION OF THE EMBODIMENTS

These and other advantages and features of the present invention and a method of achieving them will be apparent from the detailed description of the following examples. However, the present invention is not limited to the following examples and can be exemplified in various forms. That is, the examples of the present invention serve to complete the disclosure of the present invention, and are provided to make known the full scope of the invention to those of ordinary knowledge and skill in the art to which this invention belongs. This invention should be defined based on the scope of the appended claims.

Although the terms “comprising,” “including,” “having,” and “consisting of” are used through this specification, the terms can be intended to cover other elements excluding specified elements if the term “only” is not used. The singular forms “a,” “an” and “the” are intended to include the plural forms as well, unless the context clearly indicates otherwise. In describing the elements, it should also be understood that the description of the elements is intended to cover the range of errors thereof unless the context clearly indicates otherwise.

In the examples of the present invention, the respective features thereof can be partially or wholly combined or integrated, and can also be technically engaged and elaborated in various ways.

Hereinafter, exemplary embodiments of the present invention will be described in detail.

The pressure-sensitive adhesive composition according to the present invention is an acrylic pressure-sensitive adhesive composition. The pressure-sensitive adhesive composition according to one exemplary embodiment of the present invention includes a polymer formed by polymerizing a plurality of monomers. Preferably, the polymer is an acrylic polymer.

Such monomers include i) one or more selected from the group consisting of 2-ethylhexyl acrylate, butyl acrylate, isooctyl acrylate, 2-propylheptyl acrylate, n-octyl acrylate, 2-ethylhexyl methacrylate, butyl methacrylate, isooctyl methacrylate, 2-propylheptyl methacrylate, and n-octyl methacrylate, ii) one or more selected from the group consisting of acrylonitrile and methacrylonitrile, and iii) one or more selected from the group consisting of acrylic acid and methacrylic acid.

The content of i) one or more selected from the group consisting of 2-ethylhexyl acrylate, butyl acrylate, isooctyl acrylate, 2-propylheptyl acrylate, and n-octyl acrylate, 2-ethylhexyl methacrylate, butyl methacrylate, isooctyl methacrylate, 2-propylheptyl methacrylate, and n-octyl methacrylate is in a range of approximately 63 to approximately 84% by weight, preferably in a range of approximately 64 to approximately 79% by weight, and more preferably in a range of approximately 63 to approximately 69% by weight, based on the total weight of the polymer.

Also, the content of ii) one or more selected from the group consisting of acrylonitrile and methacrylonitrile is in a range of approximately 10 to approximately 30% by weight, preferably in a range of approximately 15 to approximately 28% by weight, and more preferably in a range of approximately 18 to approximately 25% by weight, based on the total weight of the polymer.

In addition, the content of iii) one or more selected from the group consisting of acrylic acid and methacrylic acid is in a range of approximately 3 to approximately 15% by weight, preferably in a range of approximately 5 to approximately 13% by weight, and more preferably in a range of approximately 5 to approximately 8% by weight, based on the total weight of the polymer.

The pressure-sensitive adhesive composition may further include a crosslinking agent in addition to the polymer. The crosslinking agent may serve to link a polymer chain with the polymer, and may also serve to control an adhesive strength and a retention force. For example, the crosslinking agent may include one or more selected from the group consisting of an isocyanate-based crosslinking agent, a bisamide-based crosslinking agent, a chelate-based crosslinking agent, a melamine-based crosslinking agent, an epoxy-based crosslinking agent, an amine-based crosslinking agent, and a urea-based crosslinking agent. Preferably, the crosslinking agent is an isocyanate-based crosslinking agent. Preferably, the content of the crosslinking agent is also in a range of approximately 0.05 to 1.00% by weight, based on the total weight of the pressure-sensitive adhesive composition.

The pressure-sensitive adhesive composition according to the present invention is a solvent-based pressure-sensitive adhesive composition, wherein a polymer is formed by polymerizing monomers in a solvent. Thereafter, the crosslinking agent may be mixed with the polymer, and the resulting mixture may be applied onto a substrate to form an adhesive article, preferably form an adhesive article in the form of a tape.

Such a solvent-based pressure-sensitive adhesive has superior water resistance, heat resistance, retention force and adhesive strength, compared to the water-based pressure-sensitive adhesive. Also, the solvent-based pressure-sensitive adhesive has an advantage in that the drying equipment costs are reduced due to a low volatilization temperature of the solvent as a dispersive medium, compared to the water-based pressure-sensitive adhesive. Therefore, the solvent-based pressure-sensitive adhesive is preferred for use in industrial products requiring a high adhesive strength, particularly for use in electronic products.

A method of preparing the solvent-based pressure-sensitive adhesive composition according to the present invention includes synthesizing a polymer by adding an initiator to a solvent, with i) one or more selected from the group consisting of 2-ethylhexyl acrylate, butyl acrylate, isooctyl acrylate, 2-propylheptyl acrylate, n-octyl acrylate, 2-ethylhexyl methacrylate, butyl methacrylate, isooctyl methacrylate, 2-propylheptyl methacrylate, and n-octyl methacrylate, ii) one or more selected from the group consisting of acrylonitrile and methacrylonitrile, and iii) one or more selected from the group consisting of acrylic acid and methacrylic acid and polymerizing the monomers. Also, the method may further include additionally adding the solvent and a crosslinking agent after the polymer is synthesized.

In this case, the solvent may include one or more selected from the group consisting of ethyl acetate and toluene. The solvent added after the polymerization may be used to dissolve a functional material additionally added after the synthesis of the polymer, and has an effect of smoothing a surface of the pressure-sensitive adhesive composition by adjusting drying volatility of the pressure-sensitive adhesive composition when the pressure-sensitive adhesive composition is coated onto a substrate.

Also, the initiator is a thermal initiator that forms reactive radicals by heat, and triggers a chain reaction of the monomers due to the reactive radicals to form a polymer. For example, the initiator may be 2-(2-cyanobutan-2-yldiazenyl)-2-methylbutanenitrile. Preferably, the initiator is present at a content of 0.1 to 1.0% by weight, based on the total weight of the pressure-sensitive adhesive composition.

A pressure-sensitive adhesive article including a pressure-sensitive adhesive layer disposed on a substrate may be formed by coating the pressure-sensitive adhesive composition of the present invention onto one or both surfaces of the substrate and drying the pressure-sensitive adhesive composition. Such a pressure-sensitive adhesive article is preferably a pressure-sensitive adhesive tape.

A release liner may be disposed on an opposite surface of the pressure-sensitive adhesive layer on which the substrate is disposed. The pressure-sensitive adhesive article may be used after such a release liner is removed from the pressure-sensitive adhesive article.

The substrate preferably includes one selected from the group consisting of a film, paper, a metal foil, and a fabric, more preferably a polyester film. However, any materials that can serve to support the pressure-sensitive adhesive layer are sufficient, but the present invention is not limited thereto.

Such a pressure-sensitive adhesive composition has high adhesive strength, water repellency and chemical resistance. In particular, the pressure-sensitive adhesive composition of the present invention may exhibit excellent chemical resistance and maintain an adhesive strength when exposed to household chemicals such as oils (e.g., olive oil), cosmetics, etc.

The chemical resistance of such a pressure-sensitive adhesive composition may be defined as follows:

Level 1: Complete peeling occurs after being immersed in chemicals;

Level 3: Partial peeling occurs after being immersed in chemicals; and

Level 5: No peeling occurs after being immersed in chemicals.

The pressure-sensitive adhesive composition according to the present invention has a resistance of Level 3 or more even after the pressure-sensitive adhesive composition has been immersed in chemicals.

The pressure-sensitive adhesive article including the pressure-sensitive adhesive composition according to the present invention may be used for household and industrial purposes. Preferably, such a pressure-sensitive adhesive article, preferably the pressure-sensitive adhesive tape is a pressure-sensitive adhesive tape for wearable devices. During use, the wearable devices may be easily exposed to various chemicals such as cosmetics, kitchen supplies, toiletries, etc. Therefore, the pressure-sensitive adhesive composition of the present invention having chemical resistance, and the pressure-sensitive adhesive article including the same are particularly desirable when used in the wearable devices.

Hereinafter, the present invention will be described in further detail with reference to experimental examples thereof. However, it should be understood that the description proposed herein is just a preferable example for the purpose of illustration only, and is not intended to limit the scope of the invention. Therefore, it will be apparent that various changes and modifications can be made to the experimental examples of the present invention without departing from the scope of the present invention, so it should be understood that the present invention covers all such changes and modifications provided they are within the scope of the appended claims and their equivalents.

The meanings of the abbreviations and trade names used to describe the following experimental examples are listed in the following Table 1.

TABLE 1
Compounds

| Abbreviations/ | |
|---|---|
| Trade names | Meaning |
| Monomers | |
| 2-EHA | 2-Ethylhexyl acrylate (CAS#103-11-7) |
| BA | Butyl acrylate (CAS#141-32-2) |
| IOA | Isooctyl acrylate (CAS#29590-42-9) |
| 2-PHA | 2-Propylheptyl acrylate (CAS#149021-58-9) |
| n-OA | n-Octyl acrylate (CAS#2499-59-4) |
| NVC | N-Vinyl caprolactam (CAS#2235-00-9) |
| NNDMA | N,N-Dimethyl acrylamide (CAS#2680-03-07) |
| AN | Acrylonitrile (CAS#107-13-1) |
| AA | Acrylic acid (CAS#79-10-7) |
| MM | Methyl methacrylate (CAS#80-62-6) |
| MA | Methacrylic acid (CAS#79-41-4) |
| IM | Isodecyl methacrylate (CAS#29964-84-9) |
| CA | Crotonic Acid (CAS#3724-65-0) |
| 2-HEA | 2-Hydroxyethyl acrylate (CAS#818-61-1 2) |
| Initiators | |
| VAZO 67 | 2-(2-Cyanobutan-2-yldiazenyl)-2- |
| | methylbutanenitrile (DuPont) |
| Solvent | |
| Ethyl acetate | Solvent for bulk polymerization and dilution |
| Toluene | Solvent for dilution |
| Crosslinking agent | |
| DESMODUR L75 | Isocyanate-based crosslinking agent (75% solid; |
| | BASF) |
| Carrier | |
| SP63B | Clear polyester film (SKC, Korea) |
| Liner | |
| SG-31 | Siliconized polyester film (SKC, Korea) |

Preparation of Pressure-Sensitive Adhesive Composition

### EXAMPLES 1, 2 AND 5 TO 18, AND COMPARATIVE EXAMPLES 1 TO 10

A 1 L flask was filled with monomers, 1 g of VAZO 67 (20% by weight of a stock solution in ethyl acetate), and 99.2 g of ethyl acetate, and sealed. The sealed flask was kept at 60° C. for 24 hours in a water bath, and the monomers were polymerized. After the polymerization, 63.3 g of ethyl acetate and 70 g of toluene were added to the flask to prepare a pressure-sensitive adhesive solution in which ethyl acetate and toluene were present at a ratio of 70:30. Additionally, 0.55% by weight of a crosslinking agent (DESMODUR L75) was added to the pressure-sensitive adhesive solution, based on the total weight of the pressure-sensitive adhesive composition, and then mixed for 30 minutes to prepare a pressure-sensitive adhesive composition.

### EXAMPLES 3 AND 4

A pressure-sensitive adhesive solution in which ethyl acetate and toluene were present at a ratio of 70:30 was prepared. Thereafter, 0.25% by weight or 1.00% by weight of a crosslinking agent (DESMODUR L75) was additionally added to the pressure-sensitive adhesive solution, based on the total weight of the pressure-sensitive adhesive composition, and then mixed for 30 minutes to prepare a pressure-sensitive adhesive composition.

### COMPARATIVE EXAMPLES 11 AND 12

The monomers and 0.2% by weight of VAZO 67 were added to a solvent in which ethyl acetate and toluene are mixed at a volume ratio of 1:1, and reacted at a constant reaction temperature of 65° C. for 7 hours to prepare a pressure-sensitive adhesive composition. Additionally, 0.55% by weight of a crosslinking agent (DESMODUR L75) was added to the pressure-sensitive adhesive solution, based on the total weight of the pressure-sensitive adhesive composition, and then mixed for 30 minutes to prepare a pressure-sensitive adhesive composition.

The components and contents of the monomers and the crosslinking agent used, and the contents of solids in the pressure-sensitive adhesive solutions are listed in the following Table 2. In the following Table 2, the contents of the monomers are based on the total weight of the polymer composed of the monomers, and the contents of the solids and the crosslinking agent are based on the total weight of the pressure-sensitive adhesive composition.

TABLE 2

| | | | | | | Content |
|---|---|---|---|---|---|---|
| | | | | | | of cross- |
| | | | | | Content | linking |
| | | | | | of solids | agent |
| Monomer components and contents | | | | | (% by | (% by |
| (% by weight) | | | | | weight) | weight) |
| | 2-EHA | AN | AA | | | |
| Example 1 | 78 | 15 | 7 | | 50 | 0.55 |
| Example 2 | 77 | 18 | 5 | | 45 | 0.55 |
| Example 3 | 78 | 15 | 7 | | 50 | 0.25 |
| Example 4 | 78 | 15 | 7 | | 50 | 1.00 |
| Example 5 | 63.75 | 28.75 | 7.5 | | 40 | 0.55 |
| Example 6 | 68.75 | 23.75 | 7.5 | | 40 | 0.55 |
| Example 7 | 75 | 10 | 15 | | 45 | 0.55 |
| Example 8 | 65 | 30 | 5 | | 40 | 0.55 |
| | BA | AN | AA | | | |
| Example 9 | 75 | 18.4 | 6.6 | | 40 | 0.55 |
| Example 10 | 80.5 | 13 | 6.5 | | 40 | 0.55 |
| Example 11 | 84 | 13 | 3 | | 40 | 0.55 |
| | 2-EHA | BA | AN | AA | | |
| Example 12 | 39 | 39 | 16.5 | 5.5 | 45 | 0.55 |
| | IOA | AN | AA | | | |
| Example 13 | 78 | 15 | 7 | | 45 | 0.55 |
| Example 14 | 75 | 18.4 | 6.6 | | 45 | 0.55 |
| | 2-PHA | AN | AA | | | |
| Example 15 | 78 | 15 | 7 | | 50 | 0.55 |
| Example 16 | 75 | 18.4 | 6.6 | | 50 | 0.55 |
| | n-OA | AN | AA | | | |
| Example 17 | 78 | 15 | 7 | | 50 | 0.55 |
| Example 18 | 75 | 18.4 | 6.6 | | 50 | 0.55 |
| | 2-EHA | AN | NVC | AA | | |
| Comparative | 77 | 13.5 | 4.5 | 5 | 45 | 0.55 |
| Example 1 | | | | | | |
| Comparative | 77 | 9 | 9 | 5 | 45 | 0.55 |
| Example 2 | | | | | | |
| Comparative | 77 | 4.5 | 13.5 | 5 | 40 | 0.55 |
| Example 3 | | | | | | |
| Comparative | 77 | 0 | 18 | 5 | 40 | 0.55 |
| Example 4 | | | | | | |
| | 2-EHA | AN | NNDMA | AA | | |
| Comparative | 77 | 13.5 | 4.5 | 5 | 45 | 0.55 |
| Example 5 | | | | | | |
| Comparative | 77 | 9 | 9 | 5 | 45 | 0.55 |
| Example 6 | | | | | | |
| Comparative | 77 | 0 | 18 | 5 | 40 | 0.55 |
| Example 7 | | | | | | |
| | 2-EHA | AN | 2-HEA | | | |
| Comparative | 77 | 21 | 2 | | 45 | 0.55 |
| Example 8 | | | | | | |
| Comparative | 76 | 20 | 4 | | 45 | 0.55 |
| Example 9 | | | | | | |
| Comparative | 74 | 18 | 8 | | 45 | 0.55 |
| Example 10 | | | | | | |
| | BA | MM | MA | | | |
| Comparative | 70 | 25 | 5 | | 45 | 0.55 |
| Example 11 | | | | | | |
| | 2-EHA | IM | CA | | | |
| Comparative | 70 | 25 | 5 | | 45 | 0.55 |
| Example 12 | | | | | | |

Preparation of Single-Coated Adhesive Tape

Corona-treated 50 μm-thick polyester base films (SP63B) were coated with the pressure-sensitive adhesive composition using notched bar coating technology. Thereafter, each of the coated base films was dried by passing through an oven in which three regions were set to 50° C., 80° C., and 110° C. respectively for approximately one minute per region for a total of approximately 3 minutes. The thickness of the dried pressure-sensitive adhesive layer was approximately 50 μm. As a release liner, a siliconized polyester film (SG-31) was laminated onto the dried pressure-sensitive adhesive layer, and then stored at 50° C. for 72 hours in a heating oven to be stabilized.

Preparation of Double-Coated Adhesive Tape

As described above, a single-coated adhesive tape was prepared, and one surface of the single-coated adhesive tape on which a pressure-sensitive adhesive layer was not formed was coated with the pressure-sensitive adhesive composition, and dried in the same manner as described above. Then, a release liner was laminated onto the dried pressure-sensitive adhesive layer, and then stabilized.

Pressure-Sensitive Adhesive Strength Test

Samples were immersed in chemicals, and the pressure-sensitive adhesive strengths of the samples were measured according to the ASTM D3330/D3330M-04 (2010) (“Standard Test Method for Peel Adhesion of Pressure-Sensitive Tape”).

More specifically, each of the prepared pressure-sensitive adhesive compositions was laminated onto a 50 μm-thick PET to prepare a test sample. The test sample was cut into pieces having a width of 5 mm, and attached to 303-stainless steel to prepare a test panel. Then, the test panel was kept at room temperature for 24 hours.

Next, the test panel was kept for 72 hours at conditions of 65° C./90% RH, and the peel strength (pressure-sensitive adhesive strength) of the test panel was measured by peeling at a rate of 300 mm/min and an angle of 180°.

Chemical Resistance Test

Each of the double-coated adhesive tapes prepared from the pressure-sensitive adhesive compositions listed in Table 2 was cut into pieces having a size of 0.5 inch×0.5 inch (1.27 cm×1.27 cm) to prepare test samples. A release liner was removed from one surface of each of the test samples, and the test samples were then attached to the bottom of a petri dish. Thereafter, a release liner was removed from the other surface of each of the test samples, and the petri dish to which the test samples were attached was kept at room temperature (approximately 23° C.) for 15 minutes.

Nest, the test samples were immersed at 70° C. for 8 hours in oleic acid or a chemical in which isopropyl alcohol (IPA) and water (H₂O) were present at a ratio of 70:30.

The results of the pressure-sensitive adhesive strength test and the chemical resistance test are listed in the following Table 3. The chemical resistance was defined as follows:

Level 1: Complete peeling occurs after being immersed in chemicals;

Level 3: Partial peeling occurs after being immersed in chemicals; and

Level 5: No peeling occurs after being immersed in chemicals.

As listed in the following Table 3, it was revealed that the pressure-sensitive adhesive compositions prepared in the examples of the present invention had a resistance of Level 3 or more even after the pressure-sensitive adhesive compositions had been immersed in chemicals.

On the other hand, it was revealed that the pressure-sensitive adhesive compositions of Comparative Examples 1 to 7 in which NVC or NNDMA was added instead of AN, the pressure-sensitive adhesive compositions of Comparative Examples 8 to 10 in which 2-HEA was added instead of AA, and the pressure-sensitive adhesive compositions of Comparative Examples 11 and 12 in which MM or MA was added or IM or CA was added instead of AN or AA have a resistance of Level 1 when immersed in at least any one chemical. In particular, it was revealed that most of the pressure-sensitive adhesive compositions of Comparative Examples 1 to 12 had a resistance of Level 1 when immersed in oleic acid.

TABLE 3

| | Pressure-sensitive | Chemical resistance | |
|---|---|---|---|
| | adhesive strength | (Level) | |
| | (kgf/5 mm) | | 70/30 |
| | 65° C./90% RH | Oleic acid | IPA/Water |
| Example 1 | 0.849 | 5 | 5 |
| Example 2 | 0.953 | 5 | 5 |
| Example 3 | 0.923 | 5 | 5 |
| Example 4 | 0.843 | 5 | 5 |
| Example 5 | 1.00 | 5 | 5 |
| Example 6 | 1.16 | 5 | 5 |
| Example 7 | 1.05 | 3 | 5 |
| Example 8 | 0.94 | 3 | 5 |
| Example 9 | 0.705 | 5 | 5 |
| Example 10 | 0.574 | 5 | 5 |
| Example 11 | 0.560 | 5 | 5 |
| Example 12 | 0.788 | 5 | 5 |
| Example 13 | 1.053 | 5 | 5 |
| Example 14 | 1.125 | 5 | 5 |
| Example 15 | 0.877 | 5 | 5 |
| Example 16 | 0.937 | 5 | 5 |
| Example 17 | 1.030 | 5 | 5 |
| Example 18 | 1.013 | 5 | 5 |
| Comparative Example 1 | 0.777 | 1 | 3 |
| Comparative Example 2 | 0.727 | 1 | 5 |
| Comparative Example 3 | 0.673 | 1 | 1 |
| Comparative Example 4 | 0.810 | 1 | 3 |
| Comparative Example 5 | 0.817 | 1 | 3 |
| Comparative Example 6 | 0.690 | 1 | 5 |
| Comparative Example 7 | 0.437 | 1 | 3 |
| Comparative Example 8 | 0.582 | 1 | 5 |
| Comparative Example 9 | 0.553 | 1 | 5 |
| Comparative Example 10 | 0.534 | 1 | 3 |
| Comparative Example 11 | 0.54 | 3 | 1 |
| Comparative Example 12 | 0.40 | 1 | 3 |

Although the preferred embodiments of the present invention have been described in detail as described above, it will be apparent to those skilled in the art that the above-described descriptions are only exemplary, and various modifications can be made to the above-described exemplary embodiments of the present invention without departing from the scope of the invention. Thus, it is intended that the present invention covers all such modifications provided they come within the scope of the appended claims and their equivalents.

1. A pressure-sensitive adhesive composition comprising a polymer formed by polymerizing a plurality of monomers,
wherein the monomers comprise i) one or more selected from the group consisting of 2-ethylhexyl acrylate, butyl acrylate, isooctyl acrylate, 2-propylheptyl acrylate, n-octyl acrylate, 2-ethylhexyl methacrylate, butyl methacrylate, isooctyl methacrylate, 2-propylheptyl methacrylate, and n-octyl methacrylate, ii) one or more selected from the group consisting of acrylonitrile and methacrylonitrile, and iii) one or more selected from the group consisting of acrylic acid and methacrylic acid; wherein the content of i) one or more selected from the group consisting of 2-ethylhexyl acrylate, butyl acrylate, isooctyl acrylate, 2-propylheptyl acrylate, n-octyl acrylate, 2-ethylhexyl methacrylate, butyl methacrylate, isooctyl methacrylate, 2-propylheptyl methacrylate, and n-octyl methacrylate is in a range of 63 to 84% by weight, the content of ii) one or more selected from the group consisting of acrylonitrile and methacrylonitrile is in a range of 10 to 30% by weight, and the content of iii) one or more selected from the group consisting of acrylic acid and methacrylic acid is in a range of 3 to 15% by weight, based on the total weight of the polymer.

2. The pressure-sensitive adhesive composition of claim 1, wherein the monomers are polymerized in a solvent using an initiator.

3. (canceled)

4. The pressure-sensitive adhesive composition of claim 1, further comprising a crosslinking agent.

5. The pressure-sensitive adhesive composition of claim 4, wherein the crosslinking agent comprises one or more selected from the group consisting of an isocyanate-based crosslinking agent, a bisamide-based crosslinking agent, a chelate-based crosslinking agent, a melamine-based crosslinking agent, an epoxy-based crosslinking agent, an amine-based crosslinking agent, and a urea-based crosslinking agent.

6. A pressure-sensitive adhesive article comprising:
a substrate; and
a pressure-sensitive adhesive layer disposed on the substrate,
wherein the pressure-sensitive adhesive layer comprises the pressure-sensitive adhesive composition defined claim 1.
